(19) United States
(12) Patent Application Publication
(10) Pub. No.: US 2005/0054305 A1
(43) Pub. Date: Mar. 10, 2005

(54) Multi-channel, signal controlled variable setting apparatus and program

(75) Inventors: Hideki Hagiwara, Hamamatsu-shi (JP); Takaaki Makino, Hamamatsu-shi (JP)

Correspondence Address: MORRISON & FOERSTER, LLP, 555 WEST FIFTH STREET, SUITE 3500, LOS ANGELES, CA, 90013-1024, US

(73) Assignee: YAMAHA CORPORATION, Hamamatsu-shi (JP)

(21) Appl. No.: 10/934,030

(22) Filed: Sep. 3, 2004

(30) Foreign Application Priority Data
Sep. 4, 2003 (JP) 2003-312242
Sep. 4, 2003 (JP) 2003-312243

(51) Int. Cl. H04L 7/00

(52) U.S. Cl. 455/126; 380/200; 375/356

(57) ABSTRACT

A multi-channel signal controlled variable setting apparatus which can easily set signal controlled variables for a group of input channels while balancing the signal controlled variable between the channels in the group. A plurality of channel-by-channel faders set volume levels of respective ones of a plurality of channels according to operated amounts. A fader group assignment operating element selects arbitrary channels and assigns a group to the selected channels. A fader group setting element sets a group by bringing together the selected arbitrary channels. A plurality of group master faders corresponding to respective ones of the groups set the volume levels of the respective ones of the groups according to operated amounts. A group volume level assigning section assigns the volume levels of the respective ones of the groups to the channels according to the operated amounts of respective ones of the group master faders. A channel-by-channel volume level setting section sets the volume levels of the respective ones of the groups while maintaining the relationship between the volume levels of the channels, which have been set according to the operated amounts of the channel-by-channel faders.

### BACKGROUND OF THE INVENTION

1. Field of the Invention

The present invention relates to a multi-channel signal controlled variable setting apparatus and program which set signal controlled variables, which are for controlling signals of a plurality of channels according to operations of operating elements, for the respective channels. For example, the present invention is applied to setting of the volume level of an audio mixer which mixes and outputs signals of a plurality of input channels.

2. Description of the Related Art

There are cases where musical tones of a performance part played by a large size musical instrument such as a drum set or a grand piano, or musical tones or speech of a performance part played by many persons such as a chorus or a group of string players are collected using an audio mixer.

For such a performance part, the operator sets a plurality of microphones and inputs signals of a plurality of input channels to the audio mixer via the microphones.

The operator operates fader operating elements for the respective input channels so as to balance the volume level between input signals from the respective microphones, which are set for the performance part.

In an orchestra performance for example, musical tone signals or speech signals from the plurality of microphones for the performance part as well as input signals of other performance parts are input to the audio mixer. To this end, the operator needs to balance the volume level between a plurality of performance parts by operating the fader operating elements for the respective input channels.

However, there may be a case where, after balancing the volume between input signals of a plurality of input channels, which correspond to one performance part, the operator would like to increase or decrease the total volume of the channels for the performance part. For example, the operator would like to produce tones by increasing or decreasing the volume level for a specific performance part as compared with other performance parts.

In such a case, it is necessary to collectively operate fader operating elements, which correspond to respective input channels for each concerned performance part, at the same rate without adversely affecting a sound field feeling and a tone color formed by setting of the microphones, but this is actually difficult.

Therefore, a fader apparatus has been developed which groups input channels into groups and adjusts the fader amounts of concerned input channels as a whole using a common group master fader operating element shared by the groups (refer to prior art described in Japanese Patent Publication No. 2,630,651).

Also, a fader apparatus has been known which sets a plurality of groups of input channels and when any fader operating element in each group is operated, fader operating elements for the other channels included in the group are forcedly driven by motor drive to balance the volume level between input channels set using fader operating elements for respective channels in an immediately preceding single operation mode (refer to Japanese Patent Publication No. 2,630,651).

According to the former prior art, however, only one group master fader is provided. Thus, if a plurality of groups are set, the group master fader must be switched over to be used for each of the plurality of groups, and hence it is difficult to balance the volume level between the groups.

Also, according to the latter prior art, if a plurality of groups of input channels are set, fader operating elements for setting the volume levels of each of the groups are located at various channel positions, and hence it is difficult to balance the volume level between the groups.

There may also be a case where the operator would like to provide mute control collectively for performance parts, for which a plurality of microphones have been set and of which output signals have been input as input signals of a plurality of channels to a mixer as described above, to temporarily mute tones, and then mix and output the input signals.

For example, in an orchestra performance, there may be a case where the operator would like to mute a main performance part so as to produce tones for background performance parts. Also, there may be a case where the operator would like to mute a performance part located at the center of a sound field so as to produce tones for peripheral performance parts.

To deal with such cases, a fader apparatus has been developed which sets a mute group of input channels subjected to mute control, and turns off an on/off operating element for any one of the input channels included in the mute group so that on/off operating elements for the other channels included in the mute group are also caused to be turned off.

However, if a plurality of mute groups are assigned, on/off operating elements which provide mute control for the respective mute groups are located at various channel positions, and hence it is difficult to provide mute control for the groups.

### SUMMARY OF THE INVENTION

It is therefore a first object of the present invention to provide a multi-channel signal controlled variable setting apparatus and a multi-channel signal controlled variable setting program which can easily set signal controlled variables for a group of input channels while balancing the signal controlled variable between the channels in the group using a plurality of group master operating elements independent of a plurality of channel-by-channel operating elements.

It is a second object of the present invention to provide a multi-channel volume level setting apparatus which sets the volume level as a signal controlled variable and can easily provide mute control for a plurality of groups.

It is a third object of the present invention to provide a multi-channel mute setting apparatus and a multi-channel mute setting program which can collectively set mute volume levels for a plurality of mute groups with ease using group mater mute operating elements independent of channel-by-channel mute operating elements.

To attain the first object, in a first aspect of the present invention, there is provided a multi-channel signal controlled variable setting apparatus comprising a plurality of channel-by-channel operating elements that set signal controlled variables for controlling signals of respective ones of a plurality of channels according to operated amounts thereof, a group assignment operating element that selects arbitrary channels from the plurality of channels and assigns a group to the selected channels, a group setting device that sets a group by bringing together the selected arbitrary channels to which the group has been assigned, to thereby set a plurality of groups, a plurality of group master operating elements that correspond to respective ones of the groups set by the group setting device and set signal controlled variables of the respective ones of the groups according to operated amounts thereof, a group signal controlled variable assigning device that assigns the signal controlled variables of the respective ones of the groups to the channels, which have been brought together into the groups by the group setting device, according to the operated amounts of respective ones of the group master operating elements, and a channel-by-channel signal controlled variable setting device that sets the signal controlled variables of the respective ones of the groups assigned to the channels by the group signal controlled variable assigning device while maintaining a relationship between the signal controlled variables set for the channels according to the operated amounts of the channel-by-channel operating elements.

Therefore, the signal controlled variables of respective groups can be set with ease using the plurality of group master operating elements independent of the channel-by-channel operating elements while maintaining a signal controlled variable balance relationship between grouped channels.

The above-mentioned signal controlled variables of respective groups may be those which are controlled in an opposite direction relative to the signal controlled variables of respective channels. For example, if the signal controlled variable is a volume level, whether the volume level (dB) of each group is to be added or subtracted is set in advance for each channel.

To attain the first and second objects, in a second aspect of the present invention, there is provided a multi-channel signal controlled variable setting apparatus comprising a plurality of channel-by-channel fader operating elements that set volume levels of respective ones of a plurality of channels according to operated amounts thereof, a plurality of channel-by-channel mute operating elements that set mute volume levels of respective ones of the plurality of channels according to switching operations thereof, a group assignment operating element that selects arbitrary channels from the plurality of channels and assigns a group to the selected channels, a group setting device that sets a group by brining together the selected arbitrary channels to which the group has been assigned, to thereby set a plurality of groups, a plurality of group master operating elements that correspond to respective ones of the groups set by the group setting device and set volume levels of the respective ones of the groups according to operated amounts thereof, a plurality of group master mute operating elements that correspond to respective ones of the groups set by the group setting device and set volume levels of the respective ones of the groups according to switching operations thereof, a group volume level assigning device that assigns the volume levels of the respective ones of the groups to the channels, which have been brought together into the groups by the group setting device, according to the operated amounts of respective ones of the group master operating elements and the switching operations of respective ones of the group master mute operating elements, and a channel-by-channel volume level setting device that sets the volume levels of the respective ones of the groups assigned to the channels by the group volume level assigning device while maintaining a relationship between the volumes levels set for the channels according to the operated amounts of the channel-by-channel operating elements and the switching operations of the channel-by-channel mute operating elements.

Therefore, the volume levels of respective groups can be set with ease using the plurality of group master operating elements independent of the channel-by-channel operating elements while maintaining a signal controlled variable balance relationship between grouped channels.

Also, mute volume levels can be collectively set by performing only one group assigning operation. Since there are a plurality of group master operating elements, the mute volume levels can be easily set for a plurality of groups.

The above-mentioned volume levels of respective groups may be those which are controlled in an opposite direction relative to the volume levels of respective channels. For example, whether the volume level (dB) of each group is to be added or subtracted is set in advance for each channel.

To attain the first object, in a third aspect of the present invention, there is provided a multi-channel signal controlled variable setting program executed by a computer, comprising a channel-by-channel operated amount input module for inputting operated amounts of a plurality of channel-by-channel operating elements that set signal controlled variables for controlling signals of respective ones of a plurality of channels, a group setting operation input module for inputting an operation of a group assignment operating element that selects arbitrary channels from the plurality of channels and assigns a group to the selected channels, a group setting module for setting a group by brining together the selected arbitrary channels by the group setting operation input module, to thereby set a plurality of groups, a group operated amount input module for inputting operated amounts of a plurality of group master operating elements that correspond to respective ones of the groups set by the group setting module and set signal controlled variables of the respective ones of the groups, a group signal controlled variable assigning module for assigning the signal controlled variables of the respective ones of the groups to the channels, which have been brought together into the groups by the group setting module, according to the operated amounts of the respective ones of the group master operating elements input by the group operated amount input module, and a channel-by-channel signal controlled variable setting module for setting the signal controlled variables of the respective ones of the groups assigned to the channels by the group signal controlled variable assigning module while maintaining a relationship between the signal controlled variables set for the channels according to the operated amounts of the channel-by-channel operating elements input by the channel-by-channel operated amount input module.

Therefore, the signal controlled variable setting apparatus according to the first aspect of the present invention can be realized in the form of a program which is executed by a computer.

Similarly, the signal controlled variable setting apparatus according to the second aspect of the present invention can be realized in the form of a program which is executed by a computer.

According to the first to third aspects of the present invention, without upsetting the balance of signal controlled variables i.e. volume levels between channels included in a group formed by bringing together a plurality of channels which have been set with difficulty and through which signals associated with each other are passed, the signal controlled variables of the respective channels included in the group can be uniformly set using the plurality of group master operating elements independent of the operating elements set for respective channels.

More specifically, the volume of a performance part played by a musical instrument such as a drum set or a piano using a plurality of channels or a performance part played by a chorus using a plurality of channels can be controlled without adversely affecting a sound field feeling and a tone color formed by setting of microphones.

Also, mute volume levels can be collectively set with ease for a plurality of channels included in each of a plurality of mute groups using the group master mute operating elements independent of the channel-by-channel mute operating elements.

To attain the third object, in a fourth aspect of the present invention, there is provided a multi-channel mute setting apparatus comprising a plurality of channel-by-channel mute operating elements that set mute volume levels of respective ones of a plurality of channels according to switching operations thereof, a mute group assignment operating element that selects arbitrary channels from the plurality of channels and assigns a mute group to the selected channels, a mute group setting device that sets a mute group by brining together the selected arbitrary channels to which the mute group has been assigned, to thereby set a plurality of mute groups, a plurality of group master mute operating elements'that correspond to respective ones of the mute groups set by the mute group setting device and set mute volume levels of the respective ones of mute groups according to switching operations thereof, a mute group volume level assigning device that assigns the mute volume levels of the respective ones of the groups set according to the switching operations of respective ones of the group master mute operating elements to the channels brought together into the mute groups by the mute group setting device, and a channel-by-channel volume level setting device that sets the mute volume levels according to either the mute volume levels of the respective ones of the channels set according to the switching operations of the channel-by-channel mute operating elements or the mute volume levels of the respective ones of the mute groups assigned to the channels brought together into the mute groups, by the mute group volume level assigning device.

Therefore, mute volume levels can be collectively set with ease for a plurality of mute groups using the group master mute operating elements independent of the channel-by-channel mute operating elements. The mute groups can be freely set independently of fader groups.

To attain the third objects, in a fifth aspect of the present invention, there is provided a multi-channel mute setting program executed by a computer, comprising a channel-by-channel mute operation input module for inputting switching operations of a plurality of channel-by-channel mute operating elements that set mute volume levels of respective ones of a plurality of channels, a mute group setting operation input module for inputting an operation of a mute group assignment operating element that selects arbitrary channels from the plurality of channels and assigns a mute group to the selected channels, a mute group setting module for setting a mute group by bringing together the selected arbitrary channels to which the mute group has been assigned by the mute group setting operation input module, to thereby set a plurality of mute groups, a group master mute operation input module for inputting switching operations of a plurality of group master mute operating elements that correspond to respective ones of the mute groups set by the mute group setting module and set mute volume levels of the ones of mute groups, a mute group volume level assigning module for assigning the mute volume levels of the respective ones of the groups set according to the switching operations of respective ones of the group master mute operating elements input by the group master mute operation input module to the channels brought together into the mute groups by the mute group setting module, and a channel-by-channel volume level setting module for setting the mute volume levels according to either the mute volume levels of the respective ones of the channels set according to the switching operations of the channel-by-channel mute operating elements input by the channel-by-channel mute operation input module or the mute volume levels of the respective ones of the mute groups assigned to the channels brought together into the mute groups, by the mute group volume level assigning module.

Therefore, the multi-channel mute setting apparatus according to the fourth aspect of the present invention can be realized in the form of a program which is executed by a computer.

According to the fourth and fifth aspects of the present invention, mute volume levels can be collectively set with ease for a plurality of mute groups, which are formed by bringing together a plurality of channels through which signals associated with each other are passed, using the group master operating elements independent of the channel-by-channel mute operating elements.

More specifically, mute volume levels can be collectively set for a performance part played by a musical instrument such as a drum set or a piano using a plurality of channels or a performance part played by a chorus using a plurality of channels.

The above and other objects, features, and advantages of the invention will become more apparent from the following detailed description taken in conjunction with the accompanying drawings.

### BRIEF DESCRIPTION OF THE DRAWINGS

FIG. 1A is a block diagram showing the hardware configuration of a multi-channel signal controlled variable setting apparatus according to an embodiment of the present invention;

FIG. 1B is a view showing a plurality of faders provided on a console appearing in FIG. 1;

FIG. 2 is a block diagram showing a first functional arrangement of the multi-channel signal controlled variable setting apparatus in FIG. 1;

FIG. 3 is a block diagram showing a second functional arrangement of the multi-channel signal controlled variable setting apparatus in FIG. 1;

FIGS. 4A to 4C are views showing operating screens according to concrete examples which realize the functional arrangements shown in FIGS. 2 and 3;

FIG. 5 is an equivalent block diagram showing a process carried out for the concrete example shown in FIGS. 4A and 4B;

FIG. 6 is an equivalent block diagram showing a process carried out for the concrete example shown in FIG. 4C; and

FIGS. 7A to 7C are flow charts showing the operation of the multi-channel signal controlled variable setting apparatus in the concrete examples described with reference to FIGS. 4A to 4C, 5, and 6.

### DETAILED DESCRIPTION OF THE PREFERRED EMBODIMENTS

The present invention will now be described in detail with reference to the drawings showing a preferred embodiment thereof.

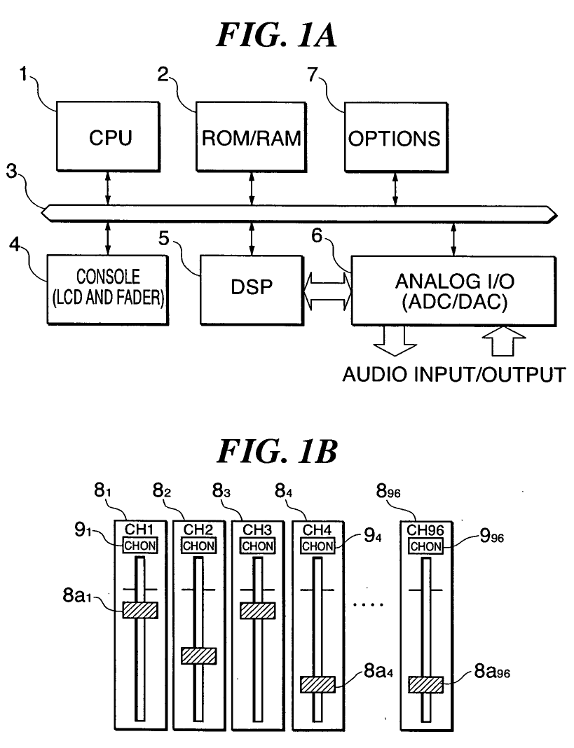

FIG. 1A is a block diagram showing the hardware configuration of a multi-channel signal controlled variable setting apparatus according to an embodiment of the present invention.

In FIG. 1A, reference numeral 1 denotes a CPU (Central Processing Unit), and reference numeral 2 denotes a ROM/RAM (Read Only Memory/Random Access Memory). In accordance with control programs stored in the ROM/RAM 2, the CPU 1 controls a display (liquid crystal display; LCD), faders, and so forth provided on a console 4 connected to a bus 3.

A digital signal processor (DSP) 5 has a function of performing various kinds of processing on a plurality of audio input signals input via an analog input/output interface 6, such as assignment (patch) to input channels; on/off state switching; volume level control; switching of input/output routes in mixing; application of effects such as reverberation, equalizer, and compressor; turning-on/off of a plurality of output channels; assignment (patch) of a plurality of output channels to output signals; and so forth, and then outputting audio signals.

The analog input/output interface 6 carries out analog-digital conversion of audio input signals and digital-analog conversion of audio signals on which digital signal processing has been performed.

Reference numeral 7 denotes optional devices which include an interface for connecting to a personal computer capable of providing the same control as the console 4, and an external storage device capable of collectively recording and reproducing control parameters such as scene data.

FIG. 1B shows an example of a plurality of faders provided on the console 4.

In the illustrated example, there are faders 8₁ to 8₉₆ for 96 channels in total. In the present embodiment, it is assumed that faders for 24 channels among the 96 channels are physically arranged on the console 4; channels to be physically arranged can be selectively switched to channels 1 to 24, channels 25 to 48, channels 49 to 72, or channels 73 to 96 using a layer switching operating element. The faders can be selectively switched to function not only for input channels, but also for output channels such as bus-out masters.

Reference numerals 9₁ to 9₉₆ denote channel on/off operating elements which are provided on the faders 8₁ to 8₉₆ for the channels 1 to 96, for turning on/off signals of the respective channels. Reference numerals 8a₁ to 8a₉₆ denote fader knobs which are slid up/down to set the volume levels of the respective channels. The fader knobs 8a₁ to 8a₉₆ may be operated by motor drive.

The faders 8₁ to 8₉₆ may be virtual faders displayed on the display (LCD) on the console 4. In this case, the faders 8₁ to 8₉₆ are operated by moving a cursor key or the like provided on a panel on the console 4 using a GUI (Graphical User Interface).

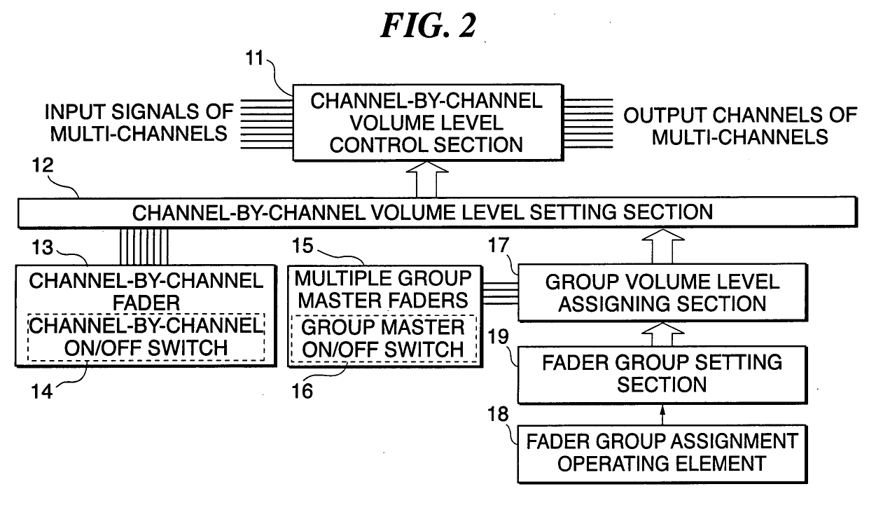

FIG. 2 is a block diagram showing a first functional arrangement of the multi-channel signal controlled variable setting apparatus in FIG. 1.

With the functional arrangement of FIG. 2 in which group faders and group on/off switches are used, volume level control and mute control are provided for groups of input channels.

A channel-by-channel volume level control section 11 appearing in FIG. 2 controls the volume levels of respective input signals of a plurality of channels and outputs the input signals as output signals of the plurality of channels. The channel-by-channel volume level control section 11 is implemented by the DSP 5 appearing in FIG. 1.

A channel-by-channel volume level setting section 12 is implemented by the CPU 1 appearing in FIG. 1.

Channel-by-channel faders 13 output operated amounts thereof to the channel-by-channel volume level setting section 12, so that the volume levels of the respective channels can be set according to the operated amounts. The channel-by-channel faders 13 correspond to the faders 8₁ to 8₉₆ appearing in FIG. 1B.

Channel-by-channel on/off switches 14 are for setting the mute volume levels (gain 0, −^{∞}dB) of the respective channels according to switching operations thereof. The channel-by-channel on/off switches 14 correspond to the channel on/off operating elements 9₁ to 9₉₆ appearing in FIG. 1B. It should be noted, however, that the channel-by-channel on/off switches 14 may be omitted.

On the other hand, group master faders 15 are provided in association with a plurality of groups, for setting the volume levels of the respective groups. The group master faders 15 are provided with respective group master on/off switches 16. The group master faders 15 output operated amounts thereof to a group volume level assigning section 17, described later, so that the volume levels of the respective groups can be set according to the operated amounts. It should be noted, however, that the group master faders 15 may not be provided with the respective group master on/off switches 16.

The group master on/off switches 16 are for setting the volume levels of the respective groups as mute volume levels according to switching operations thereof.

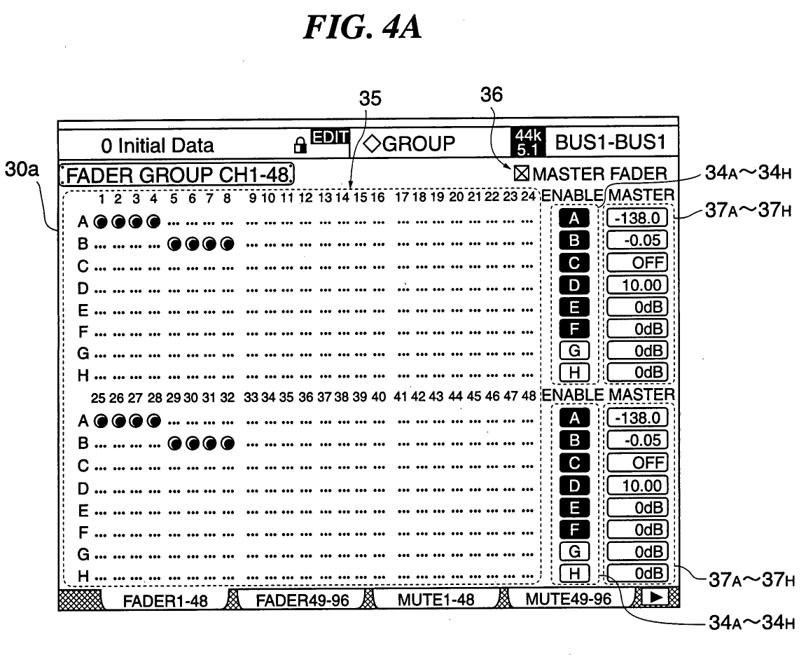

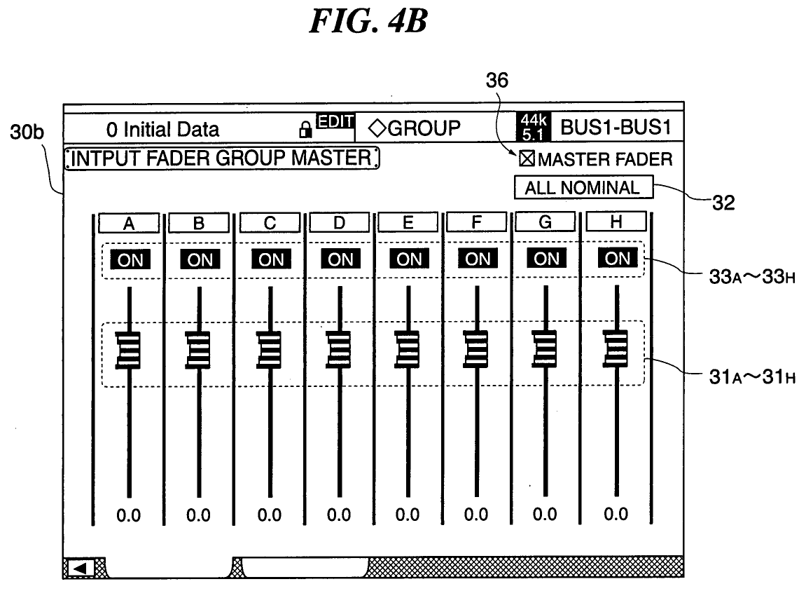

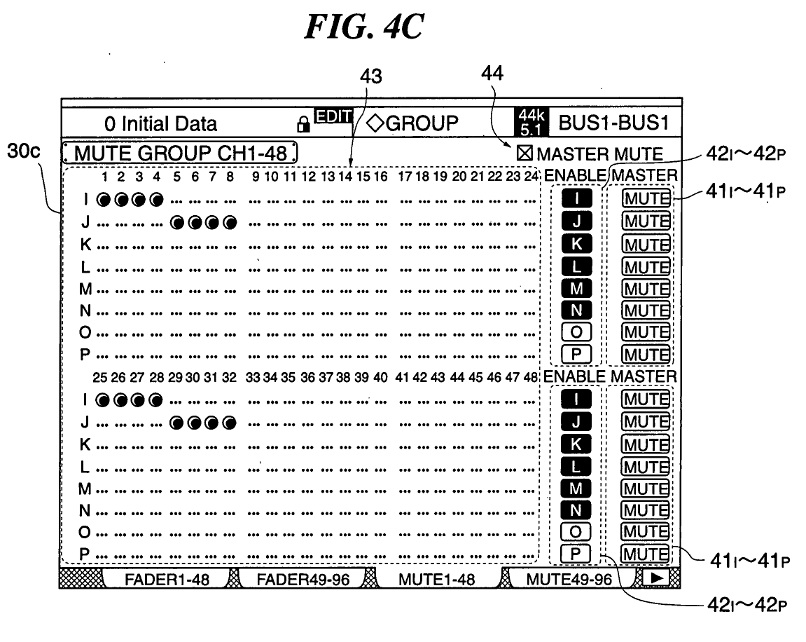

In examples described later with reference to FIGS. 4A to 4C, the group master faders 15 and the group master on/off switches 16 are virtual operating elements displayed on the display (LCD) on the console 4 appearing in FIG. 1, but they may be arranged on a panel on the console 4.

Reference numeral 18 denotes a fader group assignment operating element which is a virtual operation element displayed on the display (LCD) on the console 4 in the examples described later with reference to FIGS. 4A to 4C.

Reference numeral 19 denotes a fader group setting element which is capable of setting a plurality of groups by bringing together arbitrary channels using the fader group assignment operating element 18.

The group volume level assigning section 17 assigns the volume levels of the respective groups, which have been set according to the operated amounts of the group master faders 15, to the channels in each of the groups formed by the fader group setting section 19, and outputs the assigned volume levels to the channel-by-channel volume level setting section 12.

The functions of the fader group setting section 19 and the group volume level assigning section 17 are realized by the CPU 1 appearing in FIG. 1.

The channel-by-channel volume level setting section 12 sets the volume levels of the respective groups, which have been assigned to the channels by the group volume level assigning section 17, while maintaining the relationship between the volume levels of the respective channels set according to the operated amounts of the respective channel-by-channel faders 13 and the switching operations of the channel-by-channel on/off switches 14.

Thus, the volume levels of respective groups of input channels are set by operating the group master faders 15 while a volume balance between the channels in each of the groups set by operating the channel-by-channel faders 13 is maintained.

Specifically, the channel-by-channel-volume level setting section 12 operates such that, for each channel, a gain which represents the volume level of the channel and a gain which represents the volume level of the group, to which the channel belongs, are multiplied (the two kinds of gains are added together in terms of dB), and the resulting gain is output as the gain of volume level for controlling a signal of the channel to the channel-by-channel volume level control section 11.

Here, the channel-by-channel volume level setting section 12 does not always have to add the volume level of each channel and the volume level of the group to which the channel belongs and output the resulting volume level to the channel-by-channel volume level control section 11.

For example, for each channel, a gain which represents the volume level of the channel set in advance and a gain which represents the volume level of the group to which the channel belongs may be separately output to the channel-by-channel volume level control section 11. Even in this case, the channel-by-channel volume level control section 11 can perform the same signal processing as in the case where the gain of volume level obtained by multiplying (adding in terms of dB) the above-mentioned gains is input.

Also, the channel-by-channel volume level setting section 12 may separately output, for each channel, the volume levels, which are set, respectively, by the channel-by-channel fader 13, channel-by-channel on/off switch 14, group master fader 15, and group master on/off switch 16, to the channel-by-channel volume level control section 11.

The volume levels of the respective channels are indicated by positions to which the respective channel-by-channel fader knobs (the fader knobs 8a₁ to 8a₉₆ in FIG. 1) of the channel-by-channel faders 13 are slid.

On the other hand, the volume levels of the respective groups are indicated by positions to which the respective fader knobs of the group master faders 15 are slid. Therefore, it is possible to easily recognize and control the volume balance between a plurality of groups.

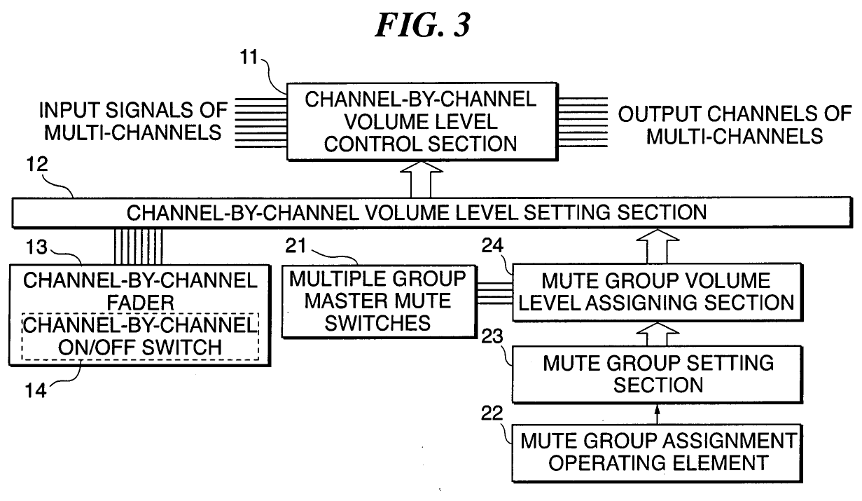

FIG. 3 is a block diagram showing a second functional arrangement of the multi-channel signal controlled variable setting apparatus in FIG. 1.

In the functional arrangement shown in FIG. 3, group master mute switches are used.

The arrangement in FIG. 2 also provides a function of providing mute control for groups, but the groups are restricted to be the same as group master fader groups.

Therefore, in the arrangement shown in FIG. 3, mute groups are set independently of group master fader groups so as to be mute-controlled independently of the group master fader groups.

It is assumed here that the arrangements in FIGS. 2 and 3 are different, but actually, they may be integrated. In FIG. 3, parts corresponding to those in FIG. 2 are denoted by the same reference numerals.

The channel-by-channel on/off switches 14 appearing in FIG. 3 are the same as those appearing in FIG. 2. The mute volume levels of respective channels are set according to switching operations of the channel-by-channel on/off switches 14.

Reference numeral 21 denotes group master mute switches which are provided in association for a plurality of groups and set the mute volume levels of respective groups according to switching operations thereof.

The group master mute switches 21 output operative statuses thereof to a mute group volume level assigning section 24, described later, so that the mute volume levels (−^{∞} dB) of respective mute groups can be set according to switching operations of the group master mute switches 21. It should be noted that, when mute volume levels are not set, the group master mute switches 21 set the volume level to 0 dB.

In the examples described later with reference to FIGS. 4A to 4C, virtual operating elements displayed on the LCD on the console 4 appearing in FIG. 1 are used, but they may be arranged on a panel on the console 4.

Reference numeral 22 denotes a mute group assignment operating element, which, in the examples described later with reference to FIGS. 4A to 4C, is a virtual operating element displayed on the display (LCD) on the console 4.

Reference numeral 23 denotes a mute group setting section which is capable of setting a plurality of groups by bringing together arbitrary channels using the mute group assignment operating element 22.

The mute group volume level assigning section 24 assigns the mute volume levels of respective groups set according to switching operations of the respective group master mute switches 21 to the channels grouped by the mute group setting section 23, and outputs the assigned mute volume levels to the channel-by-channel volume level setting section 12.

The functions of the mute group setting section 23 and the mute group volume level assigning section 17 are realized by the CPU 1 appearing in FIG. 1.

The channel-by-channel volume level setting section 12 sets the mute volume levels of respective channels according to either the mute volume levels of respective channels set according to switching operations of the channel-by-channel on/off switches 14 or the mute volume levels of respective groups assigned to channels by the mute group volume level assigning section 24.

Specifically, the channel-by-channel volume level setting section 12 operates such that, for each channel, a gain which represents the volume level of the channel and a gain which represents the volume level of the group, to which the channel belongs, are multiplied (the two kinds of gains are added together in terms of dB), and the resulting gain is output as the gain of volume level for controlling a signal of the channel to the channel-by-channel volume level control section 11.

Here, as described above with reference to FIG. 2, the channel-by-channel volume level setting section 12 does not always have to add the volume level of each channel and the volume level of the group to which the channel belongs.

FIGS. 4A to 4C are views showing operating screens according to concrete examples which realize the functional arrangements in FIGS. 2 and 3. The operating screens are displayed on the display (LCD) on the console 4 appearing in FIG. 1 and operated using a cursor key, a select key, and so forth.

In FIG. 4A, a fader group setting page 30a is displayed, and in FIG. 4B, a group master fader operating page 30b is displayed.

In FIG. 4C, a group master mute operating page 30c related to mute groups is displayed.

In FIG. 4B, reference numerals 31_{A} to 31_{H} denote group master faders, and reference numeral 32 denotes an all nominal switch. The all nominal switch 32 sets all the group master faders 31_{A} to 31_{H} to a nominal value of 0 dB and shifts the group master faders 31_{A} to 31_{H} such that respective knobs thereof indicate 0 dB.

In FIG. 4B, reference numerals 33_{A} to 33_{H} denote group master on/off switches, which set the volume levels according to operated amounts of the group master faders 31_{A} to 31_{H}. In an on-state, the group master on/off switches 33_{A} to 33_{H} set the volume levels according to operated amounts of the group master faders 31_{A} to 31_{H}, and in an off-state, the group master on/off switches 33_{A} to 33_{H} set the volume levels to −^{∞} dB (the maximum amount of attenuation).

On the fader group setting page 30a in FIG. 4A, the input channels 1 to 96 are divided into four layers, and two of the layers are displayed at the same time. In the illustrated example, a layer of the input channels 1 to 24 and a layer of the input channels 25 to 48 are displayed. On the fader group setting page 30a, input channels are displayed in a horizontal direction, and fader groups are arranged in a vertical direction. The points of intersection of the input channels with the fader groups are arranged in the form of a matrix.

In FIG. 4, reference numerals 34_{A} to 34_{H} denote group enable switches. The group enable switches 34_{A} to 34_{H} are displayed in the layers of the input channels 1 to 24 and 25 to 48. Setting of the volume levels by the group master faders 31_{A} to 31_{H} can be made when the respective corresponding group enable switches 34_{A} to 34_{H} are in an enabled state. When the group enable switches 34_{A} to 34_{H} are in a disabled state, the respective knobs of the group master faders 31_{A} to 31_{H} do not move, but the volume levels are set to 0 dB. The group enable switches 34_{A} to 34_{H} are highlighted when enabled.

In FIG. 4A, reference numeral 35 denotes group assign switches (corresponding to the fader group assignment operating element 18 appearing in FIG. 2). The group assign switches 35 are patch-board type switches for determining fader groups A to H which are to be assigned to a plurality of input channels.

The user assigns input channels to fader groups by shifting a pointer or the like from side to side and up and down using a cursor key, not shown, and putting black circular masks to the points of intersection on the matrix

In FIG. 4A, the input channels to which no black circles are put are not assigned to any groups, and hence the controlled variables for group master faders are set to 0 dB.

In the illustrated example, the input channels 1 to 4 and 25 to 28 are assigned to the group A, and the input channels 5 to 8 and 29 to 32 are assigned to the group B. In FIG. 4A, a pair of four input channels is assigned to each group, but this is not limitative.

It should be noted that the input channels 49 to 96 which are not displayed may be assigned to any of the fader groups A to H.

Master fader enable switches 36 displayed as a check box in both the fader group setting page 30a and the group master fader operating page 30b are for determining whether or not the function of controlling the fader groups using the group master faders 31_{A} to 31_{H} is to be enabled.

In FIG. 4A, reference numerals 37_{A} to 37_{H} denote display sections which indicate volume levels given to the input channels as a whole by a group master fader function using the group master faders 31_{A} to 31_{H} and other switches or the like. FIGS. 4A and 4B, however, are not depicted such that the volume levels in FIG. 4A reflect the positions of the respective knobs of the group master faders 31_{A} to 31_{H} appearing in FIG. 4B.

The display sections 37_{A} to 37_{H} are displayed in the layer of the input channels 1 to 24 and the layer of the input channels 25 to 48. The indication “OFF” in the display sections 37_{A} to 37_{H} means that a corresponding one of the group master on/off switches 33_{A} to 33_{H} is off.

As is the case with the fader group setting page 30a in FIG. 4A, on the group master mute setting page 30c in FIG. 4C, the input channels 1 to 96 are divided into four layers, and two of the layers are displayed at the same time.

In FIG. 4C, reference numerals 41_{I} to 41_{P} denote master mute switches, which are provided for independent eight groups I to P. When the master mute switches 41_{I} to 41_{P} are off, the volume levels are set to −^{∞} dB (the maximum amount of attenuation). The muted master mute switches 41_{I} to 41_{P} are highlighted. The mute groups I to P are set independently of the above-mentioned fader groups A to H.

In FIG. 4C, reference numerals 42_{I} to 42_{P} denote group enable switches, which are displayed in the layer of the input channels 1 to 24 and the layer of the input channels 25 to 48. Setting of the volume levels by the master mute switches 41_{I} to 41_{P} can be made when the corresponding group enable switches 42_{I} to 42_{P} are in an enabled state. When the group enable switches 42_{I} to 42_{P} are in a disabled state, the volume levels in muting are set to 0 dB so as to disable the muting function.

In FIG. 4C, reference numeral 43 denotes group assign switches (corresponding to the mute group assignment operating element 22 in FIG. 3), which are patch-board type switches for determining the mute groups I to P which are to be assigned to a plurality of input channels.

The user assigns input channels to mute groups by shifting a pointer or the like from side to side and up and down using a cursor key, not shown, and putting black circular masks to the points of intersection on the matrix

In FIG. 4C, the input channels to which no black circular marks are put are not assigned to any groups, and hence the controlled variables for group master faders are set to 0 dB.

In the illustrated example, the input channels 1 to 4 and 25 to 28 are assigned to the group I, and the input channels 5 to 8 and 29 to 32 are assigned to the group J.

It should be noted that the input channels 49 to 96 which are not displayed may be assigned to any of the groups I to P.

Master fader enable switches 44 displayed as a check box are for determining whether or not the function of providing mute control for each group of input channels using the group master faders 41_{I} to 41_{P} is to be enabled.

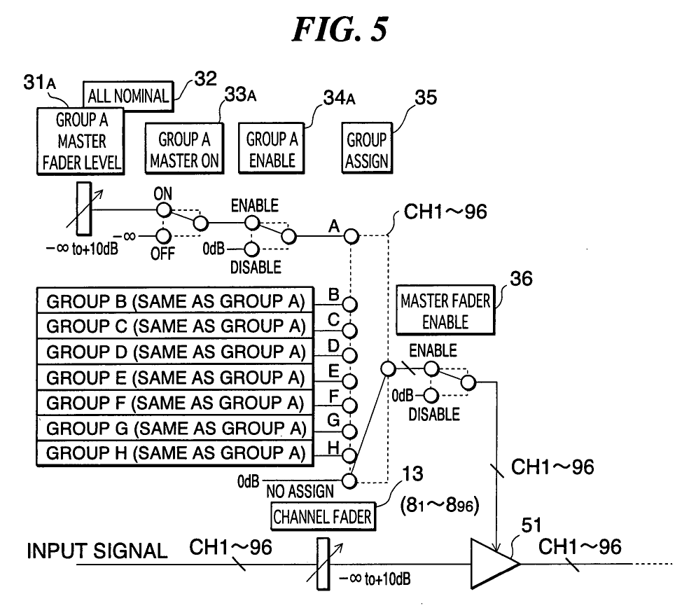

FIG. 5 is an equivalent block diagram showing a process carried out for the concrete example shown in FIGS. 4A and 4B.

In FIG. 5, parts corresponding to those in FIGS. 1 and 4A to 4C are denoted by the same reference numerals, and description thereof is omitted.

In the group A, the value of the volume level (−^{∞} to 10 dB) of the group master fader 31A is input to the group master on/off switch 33A, so that the input value or a value of −^{∞} dB is selected. However, if the all nominal switch 32 is operated, the value of the volume level of the group master fader 31A is set to 0 dB.

The value selected by the group master on/off switch 33A is input to the group enable switch 34A, so that the input value or the value of 0 dB is selected. The selected value is then input to the corresponding group assign switches 35 so as to be assigned to the input channels 1 to 4 or 25 to 28. The same applies to the groups B to H.

The group assign switches 35 are provided for the respective input channels 1 to 96, and the value of the volume level of each group is supplied to the master fader enable switches 36 provided in parallel with input channels assigned to the group. The master fader enable switches 36 for the respective input channels are switched in unison with each other to an enabled or disabled state, so that the above-mentioned value or the value of 0 dB is selected. The value selected for each channel is output to a variable amplifier 51 so as to variably control the gain.

Input signals of respective input channels are controlled to the volume levels of the respective input channels by the channel-by-channel faders 13 (8₁ to 8₉₆ in FIG. 1), and then controlled to the volume levels common to the channels in each group by the variable amplifier 51 while the relative relation in the volume levels in each group is maintained, and output to a subsequent circuit.

In the subsequent circuit, signals of the respective channels are mixed, and the mixing result is externally output as a stereo signal output, a 5.1 surround sound signal, an auxiliary signal output, or the like from the apparatus through an output channel which is set independently of an input channel.

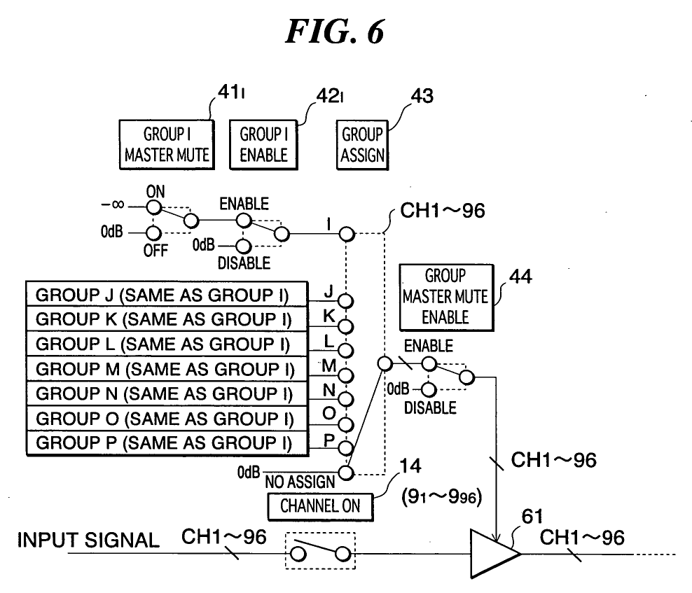

FIG. 6 is an equivalent block diagram showing a process carried out for the concrete example shown in FIG. 4C.

In FIG. 6, parts corresponding to those in FIGS. 1 and 4A to 4C are denoted by the same reference numerals, and description thereof is omitted.

In the group I, the value of the volume level (−^{∞} dB in a mute control on-state and 0 dB in a mute control off-stage) of the master mute switch 41_{I} is input to the enable switch 42_{I}, so that the input value or the value of −^{∞} dB is selected. The selected value is input to the corresponding group assign switches 43 so as to be assigned to the input channels 1 to 4 or 25 to 28. The same applies to the groups J to P.

The group assign switches 43 are provided for the respective input channels 1 to 96, and the value of the volume level of each group is supplied to the master mute enable switches 44 provided in parallel with input channels assigned to the group. The master mute enable switches 44 provided for the respective input channels are switched in unison with each other to an enabled or disabled state, so that the above-mentioned value or the value of 0 dB is selected. The value selected for each channel is output to a variable amplifier 61 so as to variably control the gain.

Input signals of respective input channels are on/off-controlled by the channel-by-channel on/off switches 14 (9₁ to 9₉₆ in FIG. 1), and then mute-controlled collectively as groups by the variable amplifier 61 and output to a subsequent circuit.

It should be noted that, in the case where the processes in FIGS. 5 and 6 are integrated, signals of input channels are controlled in volume level by the channel-by-channel faders 13 appearing in FIG. 5 and then controlled by the variable amplifier 51, and thereafter, they are controlled by the channel-by-channel on/off switches 14 and the variable amplifier 61 in FIG. 6 and output to a subsequent circuit.

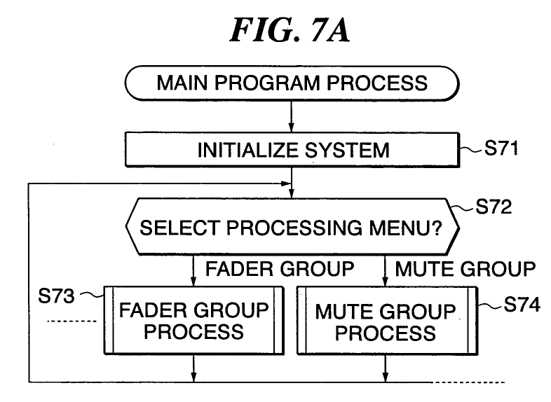

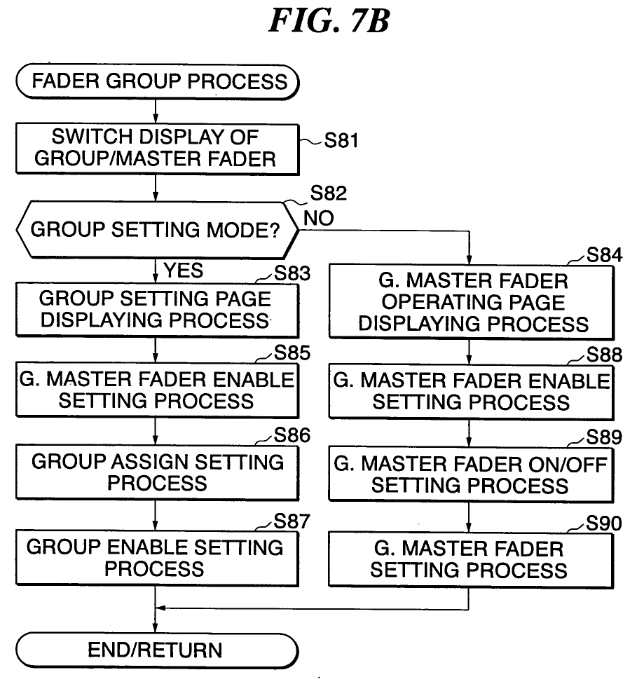

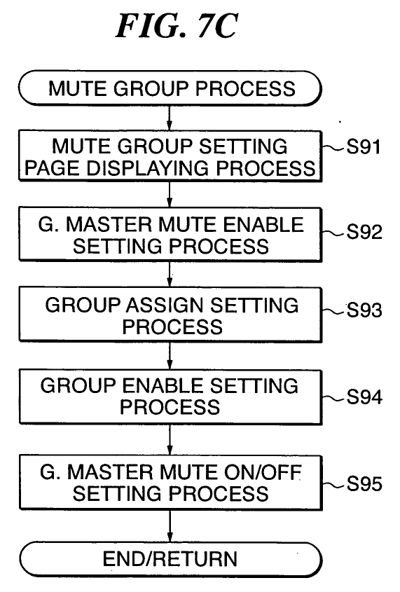

FIGS. 7A to 7C are flow charts useful in explaining the operation of the signal controlled variable setting apparatus in the concrete examples of the present invention described above with reference to FIGS. 4A to 4C, 5, and 6.

FIG. 7A is a flow chart showing a main program process.

The main program process is started upon turning-on of power supply, and the system is initialized in a step S71. In a step S72, a menu selection page, not shown, is displayed to prompt the user to select a processing menu. In the initial state of the system, the user is prompted to select the display of the fader group setting page 30a.

It should be noted that the flow chart of FIG. 7A includes a fader group process and a mute group process, but other processes are omitted. In a step S73, the processing selected in the step S72 is performed, and then the process returns to the step S72, so that the process is repeated.

FIG. 7B is a flow chart useful in explaining in detail the fader group process in the step S73 in FIG. 7A.

In a step S81, a selection input indicative of whether the fader group setting page (GROUP setting page) 30a appearing in FIG. 4A or the group master fader operating page (MASTER FADER operating page) 30b appearing in FIG. 4B is to be selectively displayed is accepted. In a step S82, it is determined whether the fader group setting page 30a or the group master fader operating page 30b has been selected in the step S81, and the process then proceeds to a step S83 or S84.

In the step S83, the fader group setting page 30a appearing in FIG. 4A is displayed.

In a step S85, an operation of the group master fader enable switch (G. MASTER FADER ENABLE) 36H is detected to determine whether or not a group volume level setting function is to be enabled. If it is determined that the group volume level setting function is not to be enabled, the group volume level of all the channels 1 to 96 is set to 0 dB.

In a step S86, operations of the group assign switches 35 are detected to set the groups A to H consisting of the channels 1 to 96.

In a step S87, operations of the group enable switches 34_{A} to 34_{H} are detected to determine whether or not a group-by-group volume setting function using the group master faders 31_{A} to 31_{H} is to be enabled. If the group-by-group volume setting function is not to be enabled, the group volume level of channels included in the concerned group is set to 0 dB.

Upon completion of the step S87, the process returns to the step S72 in FIG. 7A.

On the other hand, in the step S84, the group master fader operating page 30b appearing in FIG. 4B is displayed.

In a step S88, as is the case with the step S85, operations of the group master fader enable switches (G. MASTER FADER ENABLE) 36 are detected to determine whether or not a group volume level setting function is to be enabled. If it is determined that the group volume level setting function is not to be enabled, the group volume level of all the channels 1 to 96 is set to 0 dB.

In a step S89, operations of the group master on/off switches (MASTER FADER ON/OFF) 33_{A} to 33_{H} for the groups A to H are detected to make a setting as to whether the group master on/off switches (MASTER FADER ON/OFF) 33_{A} to 33_{H} are to be turned on or off for the respective groups A to H. If it is determined that each of the group mater on/off switches 33_{A} to 33_{H} are to be turned on, the volume level of channels included in the corresponding group is set to −^{∞} dB.

In a step S90, operations of the group master faders 31_{A} to 31_{H} for the groups A to H are detected to set the group volume level (−^{∞} to 10 dB) for each of the groups A to H according to operating positions, and the volume level of channels included in the concerned group is set to −^{∞} dB.

Further, when an operation of the all nominal switch 32 is detected, the group volume level of all the channels is set to a nominal value of 0 dB, and the respective knobs of the group master faders 31_{A} to 31_{H} are positioned at 0 dB.

Upon completion of the step S90, the process returns to the step S72 in FIG. 7A.

FIG. 7C is a flow chart showing in detail the mute group process in the step S74 in FIG. 7A.

In a step S91, the group mater mute setting page 30c appearing in FIG. 4C is displayed.

In a step S92, operations of the group master mute enable switches (GROUP MASTER MUTE ENABLE) 44 are detected to determine whether or not a group muting function is to be set. If the group muting function is not to be set, the group volume level of all the channels 1 to 96 is set to 0 dB.

In a step S93, operations of the group assign switches (GROUP ASSIGN) 43 are detected to set the groups I to P consisting of the channels 1 to 96.

In a step S94, operations of the group enable switches (GROUP ENABLE) 42_{I} to 42_{P} are detected to determine whether or not a collectively group muting function using the group master mute switches 41_{I} to 41_{P} is to be set. If the collectively group muting function is not to be set, the group volume level of channels included in the concerned group is set to 0 dB.

In a step S95, on/off operations of the group master mute switches (G. MASTER MUTE) 41_{I} to 41_{P} are detected to set the group volume level of channels included in each of the groups I to P. If the group master mute switches 41_{I} to 41_{P} are on, the volume levels of the groups I to P are se to a mute volume level (−^{∞} dB), and if the group master mute switches 41_{I} to 41_{P} are off, the volume levels of the groups I to P are set to 0 dB.

Upon completion of the step S95, the process returns to the step S72 in FIG. 7A.

In the above described embodiment, concerned input channels are grouped only once for fading and muting, but may be grouped a plurality of times in a hierarchical manner.

For example, small groups may be formed by bringing together concerned input channels, and then middle groups may be formed by bringing together the small groups. Similarly, large groups may be formed by bringing together such middle groups.

Specifically, in recording an orchestra performance, tones from a bus drum, a snare drum, a hi-hat cymbal, and so forth are each collected by a single microphone, and input channels in which the tones are input are brought together to form a small group as a drum set, and small groups of the drum set and other percussion instruments are brought together to form a middle group of percussion instruments.

Alternatively, in recording an orchestra performance, tones from a plurality of violins are each collected by a single microphone, and a small group called a first violin performance part is formed by bringing together input channels in which the tones are input, and similarly, a small group called a second violin performance part is assigned. A middle group is formed by bringing together the small groups of the first and second violin performance parts, and a large group of stringed instrument performance parts may be formed by bringing together the middle group and other small or middle groups of stringed instrument parts.

In the above described embodiment, it is assumed that the volume levels of respective channel groups are set in a manner completely following the operations of the group master faders.

However, as an alternative method of setting the volume levels of respective groups, the follow-up speed and follow-up time responsiveness caused by grouping may be set. For example, the target values of group volume levels may be given as operated amounts of the group master faders. As channel-by-channel volume levels, group volume levels which can reach the target values of group volume levels within a predetermined period of time set in advance are set and output to the channel-by-channel volume level control section. On this occasion, the above-mentioned period of time may be set to different values according to channels.

As another alternative method of setting the group volume levels, the group volume level of each group may be subtracted from the volume level of each channel instead of being added in terms of dB. It may be determined in advance whether the group volume level is to be added or subtracted for each channel. In this case, the volume levels may be set for a plurality of channels included in each group such that the volume levels of the channels are cross-faded by fading-in or fading-out relative to each other. On this occasion, in combination with the above other alternative method of setting the group volume levels, it is possible to automatically provide cross-fading control by setting the period of time as mentioned above.

In the above described embodiment, input channels are grouped for controlling the volume levels of the groups and providing mute control of the volume levels of the groups. Similarly, output channels may be grouped for the same purpose.

Further, signal processing variables other than volume level may be controlled by grouping.

For example, the sound image localization (panning) also referred to as the distribution ratio of volume level may be controlled.

For panning in which the distribution ratio of volume level between a plurality of output channels such as a 2-channel stereo or a 5.1-channel surround-sound stereo, the sound image localization (distribution ratio) of all the concerned input channels (group) relative to another group or the like can be adjusted to shift the sound image localization while the sound image localization (distribution ratio) between the concerned input channels (in each group) is maintained.

For example, in the case of a 2-channel stereo, the distribution ratio of a single input channel between right and left output channels and the distribution ratio of a group, to which the single input channel belongs, between the right and left output channels are multiplied so as to determine the final distribution ratio between the right and left output channels.

Alternatively, signal controlled variables of effects such as equalizer and compressor may be controlled by grouping.

Although in the above described embodiment, the group master faders 15 and the group master mute switches 21 are virtual operating elements displayed on a screen, physical faders similar to the channel-by-channel faders 13 may be provided on a panel on the console 4 independently of the channel-by-channel faders 13.

Further, the group master faders 15 and the group master mute switches 21 should not necessarily be fader-types, but may be implemented by other operating elements (such as a jog dial, an INC/DEC key switch, and a numeric keypad), or set values may be given through the operation of an external device connected to a network using a variety of communication protocols such as MIDI (Musical Instrument Digital Interface), USB (Universal Serial Bus), IEEE 1394, and TCP/IP (Transmission Control Protocol/Internal Protocol).

In the above described audio mixer in FIG. 1, the digital signal processor (DSP) 5 performs signal processing such as volume level control on audio input signals and outputs the resulting audio signals. The CPU 1 sets signal controlled variables such as volume level for the digital signal processor (DSP) 5.

Here, the hardware may be configured such that the digital signal processor (DSP) 5 is installed in an external digital signal processing unit.

The CPU 1 may also serve as the digital signal processor (DSP) 5 to eliminate the necessity of using the digital signal processor (DSP) 5. For example, a personal computer provided with a mixing function may be used.

The audio input signals should not necessarily be musical tone signals collected by microphones, but may be those reproduced from audio files, or waveform data generated by a tone generator which inputs musical composition data files. The audio input signals output as a result of mixing should not necessarily be sounded via speakers, but may be recorded as digital audio data or recorded in an audio file format.

It is to be understood that the object of the present invention may also be accomplished by supplying a system or an apparatus with a storage medium (or recording medium) in which a program code of software which realizes the functions of the above described embodiment is stored, and causing a computer (or CPU or MPU) of the system or apparatus to read out and execute the program code stored in the storage medium.

In this case, the program code itself read out from the storage medium realizes the functions of the embodiment described above, and hence the program code and the storage medium in which the program code is stored constitute the present invention.

Further, it is to be understood that the functions of the above described embodiment may be accomplished not only by executing a program code read out by a computer, but also by causing an operating system (OS) or the like which operates on the computer to perform a part or all of the actual operations based on instructions of the program code.

Further, it is to be understood that the functions of the above-described embodiment may be accomplished by writing a program code read out from the storage medium, into a memory provided on an expansion board inserted into a computer or in an expansion unit connected to the computer and then causing a CPU or the like provided in the expansion board or the expansion unit to perform a part or all of the actual operations based on instructions of the program code.

Further, the above program has only to realize the functions of the above-described embodiment on a computer, and the form of the program may be an object code, a program executed by an interpreter, or script data supplied to an OS.

Examples of the storage medium for supplying the program include a floppy (registered trademark) disk, a hard disk, an optical disk, a magneto-optical disk, a CD-ROM, an MO, a CD-R, a CD-RW, a DVD (DVD-ROM, DVD-RAM, DVD-RW, DVD+RW), a magnetic tape, a nonvolatile memory card, and a ROM. Alternatively, the program may be supplied by downloading from another computer, a database, or the like, not shown, connected to the Internet, a commercial network, a local area network, or the like.

1. A multi-channel signal controlled variable setting apparatus comprising:
a plurality of channel-by-channel operating elements that set signal controlled variables for controlling signals of respective ones of a plurality of channels according to operated amounts thereof;
a group assignment operating element that selects arbitrary channels from the plurality of channels and assigns a group to the selected channels;
a group setting device that sets a group by bringing together the selected arbitrary channels to which the group has been assigned, to thereby set a plurality of groups;
a plurality of group master operating elements that correspond to respective ones of the groups set by said group setting device and set signal controlled variables of the respective ones of the groups according to operated amounts thereof;
a group signal controlled variable assigning device that assigns the signal controlled variables of the respective ones of the groups to the channels, which have been brought together into the groups by said group setting device, according to the operated amounts of respective ones of said group master operating elements; and
a channel-by-channel signal controlled variable setting device that sets the signal controlled variables of the respective ones of the groups assigned to the channels by said group signal controlled variable assigning device while maintaining a relationship between the signal controlled variables set for the channels according to the operated amounts of said channel-by-channel operating elements.

2. A multi-channel signal controlled variable setting apparatus comprising:
a plurality of channel-by-channel fader operating elements that set volume levels of respective ones of a plurality of channels according to operated amounts thereof;
a plurality of channel-by-channel mute operating elements that set mute volume levels of respective ones of the plurality of channels according to switching operations thereof;
a group assignment operating element that selects arbitrary channels from the plurality of channels and assigns a group to the selected channels;
a group setting device that sets a group by brining together the selected arbitrary channels to which the group has been assigned, to thereby set a plurality of groups;
a plurality of group master operating elements that correspond to respective ones of the groups set by said group setting device and set volume levels of the respective ones of the groups according to operated amounts thereof;
a plurality of group master mute operating elements that correspond to respective ones of the groups set by said group setting device and set volume levels of the respective ones of the groups according to switching operations thereof;
a group volume level assigning device that assigns the volume levels of the respective ones of the groups to the channels, which have been brought together into the groups by said group setting device, according to the operated amounts of respective ones of said group master operating elements and the switching operations of respective ones of said group master mute operating elements; and
a channel-by-channel volume level setting device that sets the volume levels of the respective ones of the groups assigned to the channels by said group volume level assigning device while maintaining a relationship between the volumes levels set for the channels according to the operated amounts of said channel-by-channel operating elements and the switching operations of said channel-by-channel mute operating elements.

3. A multi-channel signal controlled variable setting program executed by a computer, comprising:
a channel-by-channel operated amount input module for inputting operated amounts of a plurality of channel-by-channel operating elements that set signal controlled variables for controlling signals of respective ones of a plurality of channels;
a group setting operation input module for inputting an operation of a group assignment operating element that selects arbitrary channels from the plurality of channels and assigns a group to the selected channels;
a group setting module for setting a group by brining together the selected arbitrary channels by said group setting operation input module, to thereby set a plurality of groups;
a group operated amount input module for inputting operated amounts of a plurality of group master operating elements that correspond to respective ones of the groups set by said group setting module and set signal controlled variables of the respective ones of the groups;
a group signal controlled variable assigning module for assigning the signal controlled variables of the respective ones of the groups to the channels, which have been brought together into the groups by said group setting module, according to the operated amounts of the respective ones of said group master operating elements input by said group operated amount input module; and
a channel-by-channel signal controlled variable setting module for setting the signal controlled variables of the respective ones of the groups assigned to the channels by said group signal controlled variable assigning module while maintaining a relationship between the signal controlled variables set for the channels according to the operated amounts of said channel-by-channel operating elements input by said channel-by-channel operated amount input module.

4. A multi-channel mute setting apparatus comprising:
a plurality of channel-by-channel mute operating elements that set mute volume levels of respective ones of a plurality of channels according to switching operations thereof;
a mute group assignment operating element that selects arbitrary channels from the plurality of channels and assigns a mute group to the selected channels;
a mute group setting device that sets a mute group by brining together the selected arbitrary channels to which the mute group has been assigned, to thereby set a plurality of mute groups;
a plurality of group master mute operating elements that correspond to respective ones of the mute groups set by said mute group setting device and set mute volume levels of the respective ones of mute groups according to switching operations thereof;
a mute group volume level assigning device that assigns the mute volume levels of the respective ones of the groups set according to the switching operations of respective ones of said group master mute operating elements to the channels brought together into the mute groups by said mute group setting device; and
a channel-by-channel volume level setting device that sets the mute volume levels according to either the mute volume levels of the respective ones of the channels set according to the switching operations of said channel-by-channel mute operating elements or the mute volume levels of the respective ones of the mute groups assigned to the channels brought together into the mute groups, by said mute group volume level assigning device.

5. A multi-channel mute setting program executed by a computer, comprising:
a channel-by-channel mute operation input module for inputting switching operations of a plurality of channel-by-channel mute operating elements that set mute volume levels of respective ones of a plurality of channels;
a mute group setting operation input module for inputting an operation of a mute group assignment operating element that selects arbitrary channels from the plurality of channels and assigns a mute group to the selected channels;
a mute group setting module for setting a mute group by bringing together the selected arbitrary channels to which the mute group has been assigned by said mute group setting operation input module, to thereby set a plurality of mute groups;
a group master mute operation input module for inputting switching operations of a plurality of group master mute operating elements that correspond to respective ones of the mute groups set by said mute group setting module and set mute volume levels of the ones of mute groups;
a mute group volume level assigning module for assigning the mute volume levels of the respective ones of the groups set according to the switching operations of respective ones of said group master mute operating elements input by said group master mute operation input module to the channels brought together into the mute groups by said mute group setting module; and
a channel-by-channel volume level setting module for setting the mute volume levels according to either the mute volume levels of the respective ones of the channels set according to the switching operations of the channel-by-channel mute operating elements input by said channel-by-channel mute operation input module or the mute volume levels of the respective ones of the mute groups assigned to the channels brought together into the mute groups, by said mute group volume level assigning module.
